(19) United States
(12) Patent Application Publication
(10) Pub. No.: US 2024/0403853 A1
(43) Pub. Date: Dec. 5, 2024

(54) SETTLEMENT DEVICE AND METHOD FOR SETTLEMENT DEVICE

(71) Applicant: Toshiba Tec Kabushiki Kaisha, Tokyo (JP)

(72) Inventor: Ichiro FUKUZAWA, Ota Tokyo (JP)

(21) Appl. No.: 18/617,465

(22) Filed: Mar. 26, 2024

(30) Foreign Application Priority Data
May 30, 2023 (JP) 2023-088701

(51) Int. Cl. G06Q 20/20; G06Q 20/04

(52) U.S. Cl. CPC G06Q 20/209; G06Q 20/047

(57) ABSTRACT

According to one embodiment, a settlement device for retail transaction settlement processing includes a clerk display unit, a customer display unit, and a processor. The processor is configured to receive a designation of whether a customer in a sales transaction belongs to an electronic receipt service, then cause the customer display unit to display a first display screen with selectable options for transaction receipts when the customer is not an electronic receipt service member and a second display screen with selectable options for transaction receipt output when the customer is an electronic receipt service member. The options on the first display screen are different from the options on the second display screen. The processor then receives a selectable option selection from the first or second display screen, and performs processing for the transaction receipt output according to the received selection.

### CROSS-REFERENCE TO RELATED APPLICATION

This application is based upon and claims the benefit of priority from Japanese Patent Application No. 2023-088701,filed May 30, 2023, the entire contents of which are incorporated herein by reference.

### FIELD

Embodiments described herein relate generally to a settlement device, a method therefor, and point-of-sale (POS) systems.

### BACKGROUND

There is a type of settlement device for settlement processing of purchased commodities that a customer operates by himself or herself. Because the customer operates the settlement device, a store clerk is not required and it is possible to improve work efficiency of the store clerk with regard to other tasks related to a point-of-sale (POS) system or otherwise. However, the customer needs to select a payment method from among various possible options such cash, credit card, electronic money, or the like and then perform required operations corresponding to the selected payment method. The customer also sometimes needs to select whether a receipt should be output at all or whether a paper receipt is required. There may also be different types of paper receipts that may be dispensed, such as a standard receipt or, as another type of paper receipt, an annotatable receipt (“handwritten receipt” or “memo receipt”) to be used by the customer for business expense reimbursement, separate account tracking, or the like. Furthermore, customers can now sign up for an electronic receipt service by which the customer can receive digitized electronic receipt data instead of a paper receipt. However, in view of the various possible receipt options, the customer may sometimes be confused about how to perform the receipt option selection operation when signed up for an electronic receipt service or the like.

Therefore, there is a demand for technological improvements for a settlement device to enable a customer to more easily instruct the form or format for output of a receipt at a self-service settlement device or the like at which the customer pays a transaction price by himself or herself.

### BRIEF DESCRIPTION OF THE DRAWINGS

FIG. 1 depicts a commodity sales system according to an embodiment.

FIG. 2 is a block diagram of a settlement device.

FIG. 3 is a schematic diagram illustrating a main storage region of a main memory of a settlement device.

FIG. 4 is a block diagram depicting functional aspects of a processor of a settlement device.

FIG. 5 is a flowchart of first information processing executed by a processor.

FIG. 6 is a flowchart of second information processing executed by a processor.

FIG. 7 is a flowchart of second information processing.

FIG. 8 is a flowchart of receipt output processing executed by a processor.

FIG. 9 is an example of a registration screen displayed on a touch panel of an input device.

FIG. 10 is an example of a registration screen displayed on a display of an input device.

FIG. 11 is an example of a subtotal screen displayed on a touch panel of an input device.

FIG. 12 is an example of a first notification screen displayed on a display.

FIG. 13 is an example of a second notification screen displayed on a display.

FIG. 14 is an example of a total screen displayed on a first touch panel of the settlement device.

FIG. 15 is a schematic diagram illustrating a transition example of information displayed in a second customer area of a total screen.

FIG. 16 is an example of a first operation screen displayed on a second touch panel of a settlement device.

FIG. 17 is an example of a second operation screen displayed on a second touch panel.

FIG. 18 is an example of a payment method selection screen displayed on a second touch panel.

FIG. 19 is an example of a payment method selection screen displayed on a first touch panel.

FIG. 20 is an example of a store clerk operation-in-progress screen displayed on a second touch panel.

FIG. 21 is an example of a payment support screen displayed on the second touch panel.

FIG. 22 is an example of a payment check screen displayed on a second touch panel.

FIG. 23 is an example of a payment completion screen displayed on a first touch panel.

FIG. 24 is an example of a payment completion screen displayed on a second touch panel.

FIG. 25 is a diagram illustrating transition of screens displayed on a first touch panel and a second touch panel when a customer performs a price payment operation.

FIG. 26 is a diagram illustrating transitions of screens displayed on a first touch panel and a second touch panel when a store clerk performs a selection operation for selecting a price payment method instead of a customer.

### DETAILED DESCRIPTION

A described embodiment provides a settlement device and a method therefor that represents a technological improvement in existing systems as it enables a customer to more easily instruct the format for a requested sales transaction receipt from the settlement device.

In general, according to one embodiment, a settlement device for retail transaction settlement processing includes a clerk display unit, a customer display unit, and a processor. The processor is configured to: receive a designation of whether a customer in a sales transaction is an electronic receipt service member, then cause the customer display unit to display a first display screen with selectable options for transaction receipt output when the received designation indicates the customer is not the electronic receipt service member and a second display screen with selectable options for transaction receipt output when the received designation indicates the customer is the electronic receipt service member. The selectable options of the first display screen are different from the selectable options of the second display screen. The processor is further configured to receive a selection of a selectable option on the first or second display screen, then perform processing for the transaction receipt output according to the received selection of the selectable option.

Certain example embodiments of a settlement device that enable a store clerk to intervene in the payment (settlement) processing of a sales transaction without confusion at a self-service settlement device at which the customer pays a settlement price by himself or herself is explained with reference to the drawings. Note that, in an example embodiment, a commodity sales system is illustrated in which an input device for a customer (a consumer) to input information concerning a commodity to be purchased and a settlement device for settlement of a transaction by the customer are physically separated.

### Explanation of a Configuration of a Commodity Sales System

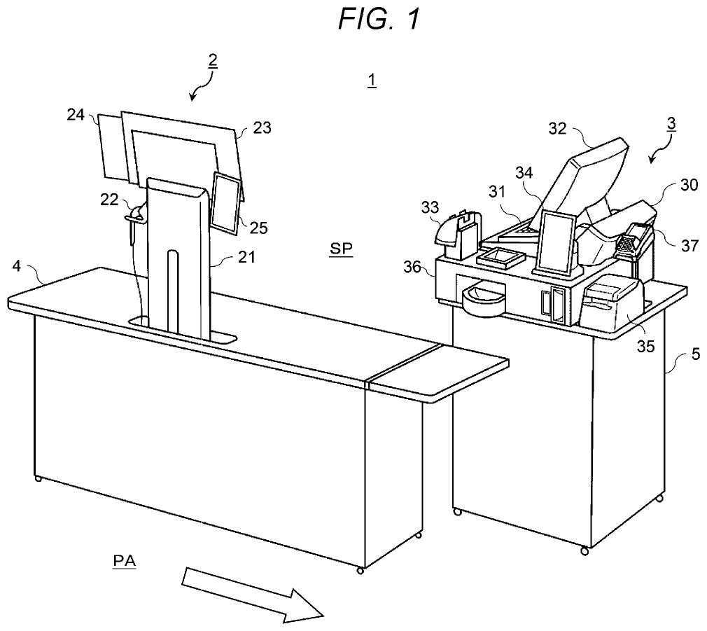

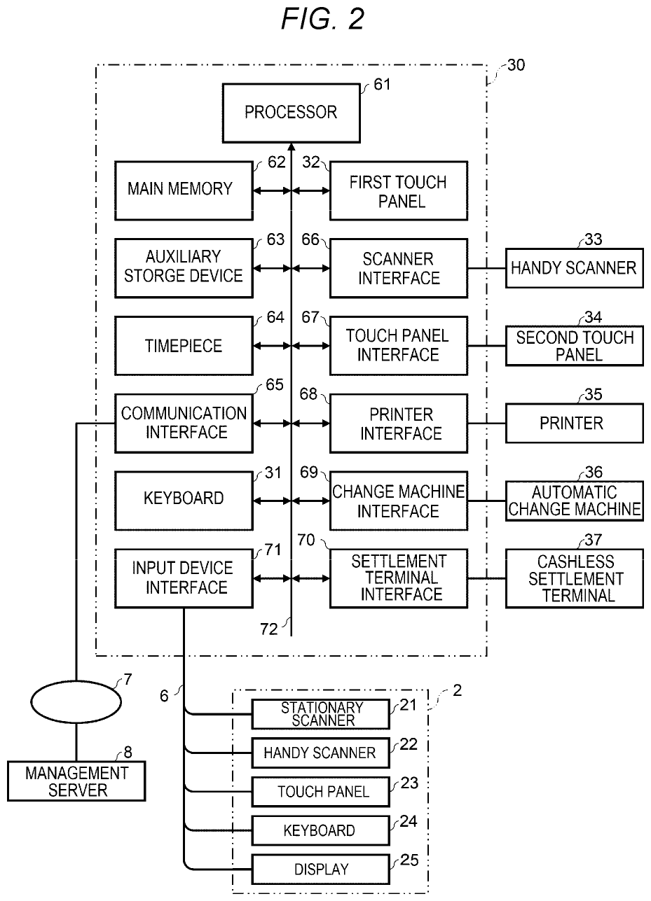

FIG. 1 is a schematic configuration diagram of a commodity sales system 1 according to an embodiment. The commodity sales system 1 includes an input device 2 (registration device) and a settlement device 3. The input device 2 and the settlement device 3 are connected by a transmission cable 6 (see FIG. 2) such as a LAN (Local Area Network) cable. The commodity sales system 1 is connected to a store server, an electronic receipt management server 8 (hereinafter, management server 8) that provides an electronic receipt service, and the like via a communication network 7, comprising a LAN and/or the Internet (see FIG. 2).

The input device 2 is attached to a checkout counter 4. The checkout counter 4 is disposed along a checkout lane PA on which a customer (purchaser) walks in the direction of the illustrated arrow. The input device 2 is attached at substantially the center of the top surface of the checkout counter 4. A space further on an upstream side of the checkout lane PA than the input device 2 is set as a space for placing a commodity before input of a commodity code. A space on a downstream side of the checkout lane PA than the input device 2 is set as a space for placing the registered commodity after the input of the commodity code. The input device 2 is any device for inputting a commodity code of the purchased commodity. The settlement device 3 is a device for storing, in a main memory 62, information concerning the registered purchased commodity information as input by the input device 2. The storing of the information concerning the purchased commodity in the main memory 62 in this way is referred to as registration or a registration process. The settlement device 3 performs settlement of a transaction based on the information registered in the main memory 62.

The input device 2 includes a stationary scanner 21, a handy scanner 22, a touch panel 23, a keyboard 24, and a display 25 as input and output devices. The stationary scanner 21 is disposed to project upward from the top surface of the checkout counter 4 and the handy scanner 22, the touch panel 23, the keyboard 24, and the display 25 are disposed at positions around the stationary scanner 21.

Specifically, the stationary scanner 21 is fixed to the top surface of the checkout counter 4. The stationary scanner 21 is a vertical type and is fixed such that a barcode reading window is located on a surface on the opposite side of the checkout lane PA. The handy scanner 22 is mounted to one side section of the stationary scanner 21. The touch panel 23 is attached to an upper part of the stationary scanner 21 such that an operation panel surface of the touch panel 23 faces the same direction as the reading window of the stationary scanner 21. The keyboard 24 is attached to one side section of the touch panel 23 such that a key surface of the keyboard 24 faces the same direction as the operation panel surface of the touch panel 23. Further, the display 25 is attached to one side section of the stationary scanner 21 such that a display screen of the display 25 faces the checkout lane PA. Note that the display 25 may be a touch panel.

With the disposition of the input and output devices explained above, a store clerk standing in a space SP on the opposite side of the checkout lane PA across the checkout counter 4 can operate the stationary scanner 21, the handy scanner 22, the touch panel 23, or the keyboard 24 and input information relating to a purchased commodity, for example, a commodity code, a purchase quantity, a price-cut amount, and the like. At this time, the store clerk can check a commodity name, unit prices, and the like of the purchased commodity against the information displayed on the touch panel 23. The customer can also check the commodity name, the unit price, and the like of the purchased commodity against the information displayed on the display 25. If the customer is registered as a member of an electronic receipt service, the customer can input identification information (an electronic receipt member ID) for identifying the electronic receipt member. For example, if the customer presents a barcode for an electronic receipt member ID displayed on a smartphone or the like, the store clerk reads the barcode with the handy scanner 22. Consequently, data of the electronic receipt member ID can be input. Receipt data indicating details of a commercial transaction with the customer can then t be dispensed as an electronic receipt (electronic receipt format).

In order to use the electronic receipt service, the customer needs to perform member registration beforehand with the electronic receipt service. Data of the customer registered as a member is managed in the management server 8. After the customer performs member registration, a unique electronic receipt member ID is issued to the customer. For example, if the customer installs an application program exclusive to the electronic receipt service in a smartphone owned by the customer, the electronic receipt member ID may be set in the program (an electronic receipt application) as issued.

The settlement device 3 includes a keyboard 31 and a first touch panel 32 integrated with a device main body 30. The settlement device 3 includes a handy scanner 33, a second touch panel 34, a printer 35, an automatic change machine 36, a cashless settlement terminal 37, and the like externally attached to the device main body 30. The settlement device 3 is placed on the top surface of a register counter 5 installed on the opposite side of the checkout lane PA near a downstream side end portion in the checkout counter 4.

Specifically, the device main body 30 is placed on the register counter 5 such that a key surface of the keyboard 31 and an operation panel surface of the first touch panel 32 face the side of the space SP where the store clerk stands. The handy scanner 33, the second touch panel 34, the printer 35, and the automatic change machine 36, and the cashless settlement terminal 37 are disposed around the device main body 30. The handy scanner 33 is disposed in a position where the store clerk standing in the space SP is capable of operating the handy scanner 33. The second touch panel 34 is disposed in a position where the customer standing in the checkout lane PA is capable of viewing a display surface of the second touch panel 34. The printer 35 is disposed in a position where the customer standing in the checkout lane PA can easily receive a receipt. The automatic change machine 36 is disposed in a position where the customer standing in the checkout lane PA can easily deposit money and receive dispensed change. The cashless settlement terminal 37 is disposed in a position where the customer standing in the checkout lane PA can easily operate the cashless settlement terminal 37 for performing cashless settlements such as credit card settlement, electronic money settlement, or code settlement.

The operator of the keyboard 31, the first touch panel 32, and the handy scanner 33 is the store clerk. The operator of the second touch panel 34, the printer 35, the automatic change machine 36, and the cashless settlement terminal 37 is the customer. That is, the first touch panel 32 displays information to the store clerk and can be operated by the store clerk. The second touch panel 34 displays information to the customer and can be operated by the customer.

In general, in a large retail store such as a supermarket or a home improvement center, a plurality of commodity sales systems 1 are installed in parallel in a checkout place (a register area) divided from a selling floor where commodities are displayed. However, in a small retail store such as a specialty store, only one commodity sales system 1 may sometimes be installed in the store.

### Explanation of a Configuration of the Settlement Device

FIG. 2 is a block diagram illustrating a configuration of the settlement device 3. As illustrated in FIG. 2, the settlement device 3 includes, in the device main body 30, a processor 61, a main memory 62, an auxiliary storage device 63, a timepiece 64, a communication interface 65, a scanner interface 66, a touch panel interface 67, a printer interface 68, a change machine interface 69, a settlement terminal interface 70, and an input device interface 71. The processor 61 and the main memory 62, the auxiliary storage device 63, the timepiece 64, the communication interface 65, the scanner interface 66, the touch panel interface 67, the printer interface 68, the change machine interface 69, the settlement terminal interface 70, and the input device interface 71 are connected by a system transmission line 72. The system transmission line 72 is a transmission line including an address bus, a data bus, and a control signal line.

In the settlement device 3, the processor 61 and the other components are connected by the system transmission line 72. In the settlement device 3, the keyboard 31 and the first touch panel 32 are connected via the system transmission line 72.

The processor 61 controls the units in order to implement various functions of the settlement device 3 according to an operating system or application programs. The processor 61 is, for example, a CPU (Central Processing Unit). The processor 61 can be a multicore processor including a plurality of processor cores to be capable of executing a plurality of kinds of processing in parallel.

The main memory 62 includes a nonvolatile memory region and a volatile memory region. The main memory 62 stores the operating system and/or the application programs in the nonvolatile memory region. The main memory 62 sometimes stores, in the nonvolatile or volatile memory region, data necessary for the processor 61 in executing processing for controlling the components. The main memory 62 uses the volatile memory region as a work area where data can be rewritten as appropriate by the processor 61. The nonvolatile memory region is, for example, a ROM (Read Only Memory). The volatile memory region is, for example, a RAM (Random Access Memory).

The auxiliary storage device 63 is, for example, an EEPROM (Electric Erasable Programmable Read-Only Memory), an HDD (Hard Disk Drive), an SSD (Solid State Drive), or the like. The auxiliary storage device 63 stores data used by the processor 61 in performing various kinds of processing, data created by the processing in the processor 61, and the like. The auxiliary storage device 63 may sometimes store application programs.

The timepiece 64 (clock) tracks or provides a date and time. The processor 61 processes, as the present date and time, the date and the time provided by the timepiece 64.

The communication interface 65 is for performing data communication with the store server connected via the communication network 7 or the management server 8 that manages the electronic receipt service. The store server is a computer with a commodity master (master table) that stores commodity data such as commodity names and unit prices of all the commodities sold in a store. The store server is for collecting and totaling sales data of commodities processed by the settlement device(s) 3 and tracking sales, stocks, and the like of the entire store. The management server 8 is a computer for collecting and managing data concerning customers who have registered as users of the electronic receipt service. The management server 8 stores, for example, electronic receipt data obtained by digitizing a sales receipt for a transaction (settlement) with a customer and an electronic receipt member ID in an electronic receipt database in correlation with each other.

The scanner interface 66, the touch panel interface 67, the printer interface 68, the change machine interface 69, and the settlement terminal interface 70 are interfaces for performing data communication with the respective devices externally attached to the device main body 30. That is, the scanner interface 66 performs the data communication with the handy scanner 33. The touch panel interface 67 performs the data communication with the second touch panel 34. The printer interface 68 performs the data communication with the printer 35. The change machine interface 69 performs the data communication with the automatic change machine 36. The settlement terminal interface 70 performs the data communication with the cashless settlement terminal 37.

The input device interface 71 is for performing the data communication with the input device 2 that is connected by the transmission cable 6. That is, the input device interface 71 performs the data communication with the stationary scanner 21, the handy scanner 22, the touch panel 23, the keyboard 24, and the display 25.

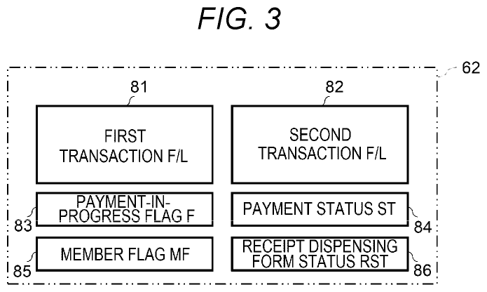

FIG. 3 is a schematic diagram illustrating a main storage region formed in the main memory 62. In the settlement device 3, parts of a volatile storage region in the main memory 62 are set as regions for a first transaction file 81, a second transaction file 82, a flag memory 83, a status memory 84, a member flag memory 85, and a receipt dispensing form memory 86. Both the first transaction file 81 and the second transaction file 82 are regions for storing sales data of purchased commodities processed as one transaction. The sales data includes items of information such as commodity codes, commodity names, unit prices, purchase quantities, and sales amounts for the purchased commodities. The sale amounts are amounts obtained by multiplying the unit prices by the purchase quantities. The first transaction file 81 stores the sales data relating to the purchased commodities from a start until an end of input of the commodity codes (registration) of the purchased commodities in the transaction. The second transaction file 82 stores the sales data from the end of the input of the commodity codes (registration) of the purchased commodities until the transaction is settled (completed). Note that “registration of the purchased commodities” in this context includes any method or means for gathering and storing data of the purchased commodities in the settlement device 3. The first transaction file 81 and the second transaction file 82 store information (for example, information relating to a commodity to be purchased by the customer, such as a commodity code, a purchase quantity, and a price-cut amount) input by the stationary scanner 21, the handy scanner 22, the touch panel 23, or the keyboard 24 of the input device 2 or information (for example, information relating to a commodity to be purchased by the customer, such as a commodity code, a purchase quantity, and a price-cut amount) as may be input by the keyboard 31 or the first touch panel 32.

The flag memory 83 is a region for storing a payment-in-progress flag F. The payment-in-progress flag F is one-bit data for identifying whether settlement is presently ongoing at the settlement device 3. In this embodiment, the payment-in-progress flag F with a value of “1” represents payment is ongoing and a value of “0” represents otherwise.

The status memory 84 is a region for storing a payment status ST. The payment status ST indicates a payment mode setting. As the payment modes, there are a self-mode and a support mode. The self-mode is a mode in which the customer performs price payment operation by himself or herself. The support mode is a mode in which the store clerk intervenes in the price payment operation to assist the customer. In this embodiment, the payment status ST value representing the self-mode is “10” and the payment status ST value representing the support mode is “20”. The payment status ST value for the period before the price payment operation has started is “00”.

The member flag memory 85 is a region for storing the member flag MF. The member flag MF is one-bit data for identifying whether the customer is an electronic receipt member. In this embodiment, if the electronic receipt member ID is acquired in the input device 2, the member flag MF value indicating that the customer is an electronic receipt member is “1” and “0” when the customer is not an electronic receipt member.

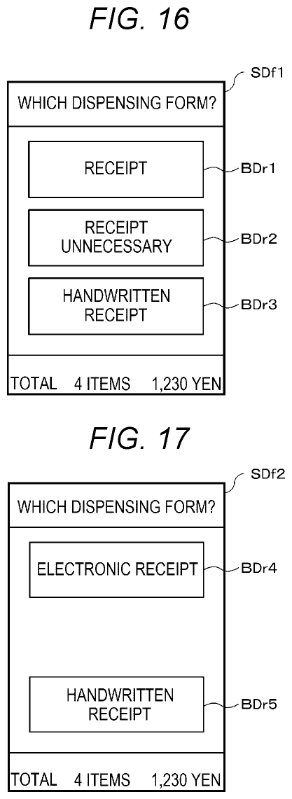

The receipt dispensing form memory 86 is a region for storing a receipt dispensing format status RST. The receipt dispensing format status RST value indicates a receipt dispensing form (format) designated by selection operation by the customer via an operation screen. The receipt dispensing form can be different according to whether the customer is an electronic receipt member or has designated a format selection on the operation screen for the receipt dispensing. If the customer is not an electronic receipt member, then the possible receipt dispensing form statuses RST corresponding to options on a first operation screen (see FIG. 16), are “01” representing selection of a paper receipt, “02” representing selection unnecessity of output of the paper receipt (the no receipt option), and “03” representing selection of a handwritten receipt. If the customer is an electronic receipt member, then the possible receipt dispensing form statuses RST corresponding to options on a second operation screen (see FIG. 17), are “11” representing selection of an electronic receipt and “13” representing selection of a handwritten receipt.

Note that the basic receipt can be, for example, paper on which details (a commodity name, the number of items, a total, a deposit, and the like) of a purchased commodity are printed. The handwritten receipt (“reimbursement receipt”) has an addressee field added to the basic receipt so includes a purchase amount, dispensing store information, and a remarks section (also referred to as “a handwriting field” or “memo field”) permitting the customer to subsequently add information concerning a purchased commodity, for example, “for xx”). The handwritten receipt may be formed integrally with an otherwise standard receipt on which the details of the purchased commodity are shown.

### Explanation of Functions of the Settlement Device

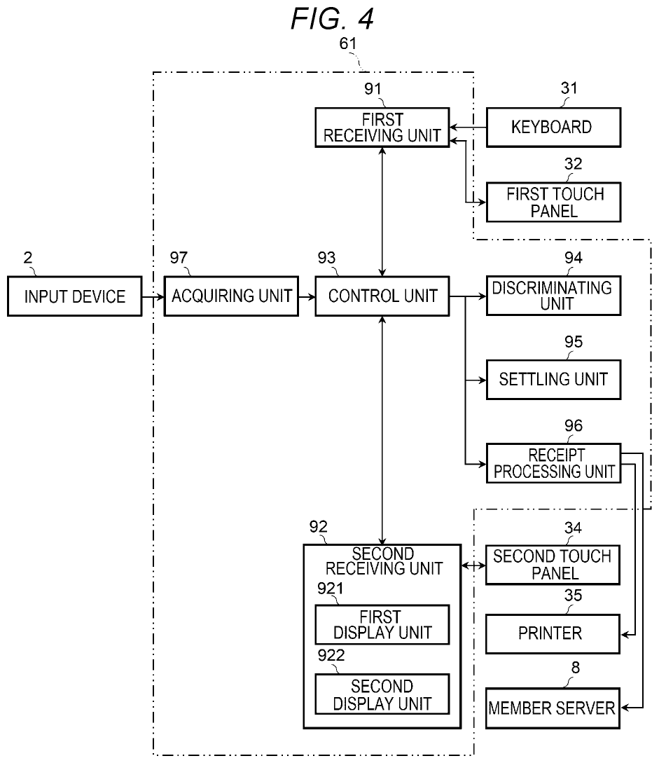

FIG. 4 is a block diagram illustrating functional aspects of the processor 61 of the settlement device 3. As illustrated in FIG. 4, the processor 61 provides functions of a first receiving unit 91, a second receiving unit 92, a control unit 93, a discriminating unit 94, a settling unit 95, a receipt processing unit 96, and an acquiring unit 97.

The first receiving unit 91 receives a selection input for a price payment method out of a plurality of price payment methods options according to operation of the store clerk. Specifically, the first receiving unit 91 causes the first touch panel 32 to display a payment method selection screen and receives the selection input for selection/designation of a price payment method. The first receiving unit 91 receives selection input from one of a plurality of payment keys to which available price payment methods are respectively allocated among various keys disposed on the keyboard 31, for example. The first receiving unit 91 receive may selection input via a direct operation/designation by the store clerk or otherwise rather than via a multiple option selection screen or the like. In this case, specifically, the first receiving unit 91 causes the first touch panel 32 to display a screen including a button for executing (determining) payment and receives an instruction to execute (determine) price payment. The first receiving unit 91 may be provided with, among the various keys disposed on the keyboard 31, an execution key for executing operation for executing (determining) price payment and configured to receive selection input for executing (determining) price payment with the execution key.

The second receiving unit 92 receives selection input for a price payment method selected out of a plurality of price payment methods options according to operation of the customer. Specifically, the second receiving unit 92 causes the second touch panel 34 to display a payment method selection screen and receives the selection input for a price payment method. The second receiving unit 92 may be a function of receiving selection input for operation for executing (determining) price payment according to operation of the customer instead of receiving the selection input for any price payment method out of the plurality of kinds of price payment methods according to the operation of the customer. In this case, specifically, the second receiving unit 92 may be configured to cause the second touch panel 34 to display a screen including a button for determining payment and receive an instruction to execute (determine) price payment.

The second receiving unit 92 causes the second touch panel 34 to display an operation screen including choices concerning receipt dispensing and receives a selection operation for a dispensing form of a receipt according to operation of the customer. Specifically, the second receiving unit 92 includes a first display unit 921 and a second display unit 922. If the discriminating unit 94 discriminated that the customer is not an electronic receipt member, the first display unit 921 causes the second touch panel 34 to display a first operation screen (see FIG. 16) including choices of a dispensing form of a paper receipt. If the discriminating unit 94 discriminated that the customer is an electronic receipt member, the second display unit 922 causes the second touch panel 34 to display a second operation screen (see FIG. 17) not including choices of a dispensing form of a paper receipt but including choices of a dispensing form of an electronic receipt.

The control unit 93 controls the functions 91, 92, and 94 to 97. The control unit 93 controls the first receiving unit 91 and the second receiving unit 92 and, if one of the receiving units is receiving selection input for a dispensing form of a receipt and a price payment method, controls the other receiving unit not to receive the selection input concurrently. Specifically, while the control unit 93 causes one touch panel of the first touch panel 32 and the second touch panel 34 to display the operation screen (the first operation screen or the second operation screen) concerning receipt dispensing or the payment method selection screen, the control unit 93 controls the other touch panel not to display the operation screen or the payment method selection screen. For example, if causing the second touch panel 34 to display the first operation screen or the second operation screen, the control unit 93 controls the first touch panel 32 not to display the first operation screen and the second operation screen. The control unit 93 does not receive operation by input of the keys disposed on the keyboard 31. The control unit 93 waits for receiving a display switching operation by the store clerk. If detecting the switching operation, the control unit 93 causes the first touch panel 32 to display the operation screen and erases the operation screen from the second touch panel 34. The control unit 93 receives selection input for a receipt dispensing form by input of the keys disposed on the keyboard 31.

The discriminating unit 94 discriminates (identifies) whether the customer (the consumer) is an electronic receipt member with reference to the member flag MF set by the electronic receipt member ID input in the input device 2 being acquired by the acquiring unit 97.

The settling unit 95 provides a function of performing settlement for a purchased commodity with an amount input by operation of the customer. For example, if cash was deposited to the automatic change machine 36, the settling unit 95 regards that a payment amount by cash was deposited and executes cash settlement processing. For example, if data of a credit card was read by the cashless settlement terminal 37, the settling unit 95 regards that a payment amount by the credit card was deposited and executes credit card settlement processing. For example, if electronic money was read by the cashless settlement terminal 37, the settling unit 95 regards that a payment amount by electronic money was deposited and executes electronic money settlement processing. For example, if a barcode or a two-dimensional code for code settlement was read by the cashless settlement terminal 37, the settling unit 95 regards that the balance specified by the barcode or the two-dimensional code was deposited as a payment amount and executes code settlement processing. Since the settlement processing such as the cash settlement processing, the credit card settlement processing, the electronic money settlement processing, and the code settlement processing is well-known processing, detailed explanation of the settlement processing is omitted here.

The receipt processing unit 96 executes, via the operation screen (the first operation screen or the second operation screen) displayed by the second receiving unit 92, receipt output processing concerning a receipt for settlement by the settling unit 95 according to the receipt dispensing form selected by the operation of the customer.

The acquiring unit 97 acquires information relating to a transaction with the customer input by operation of the store clerk on the input device 2. The acquiring unit 97 acquires a commodity code, a purchase quantity, a price-cut amount, and the like as information relating to a purchased commodity. If an electronic receipt member ID is presented by the customer via the input device 2, the acquiring unit 97 also acquires the electronic receipt member ID of the customer from the input device 2. When the electronic receipt member ID is acquired, the member flag MF is updated from “0” to “1”.

With the functions explained above, the processor 61 of the settlement device 3 acts as explained below. That is, the first operation screen including choices of a dispensing form of a paper receipt by the first display unit 921 and the second operation screen not including choices of a dispensing form of a paper receipt but including choices of a dispensing form of an electronic receipt by the second display unit 922 is displayed according to whether the customer is an electronic receipt member as discriminated by the discriminating unit 94 based on the member flag MF set by the electronic receipt member ID of the customer being acquired from the input device 2 by the acquiring unit 97. If settlement is performed by the settling unit 95 and a receipt is output, processing concerning the receipt is executed by the receipt processing unit 96 according to a receipt dispensing format selected by capture operation on the first operation screen or the second operation screen.

Since either the first operation screen or the second operation screen including different choices will be displayed according to whether the customer is an electronic receipt member, it is possible to easily select a format for output of a receipt.

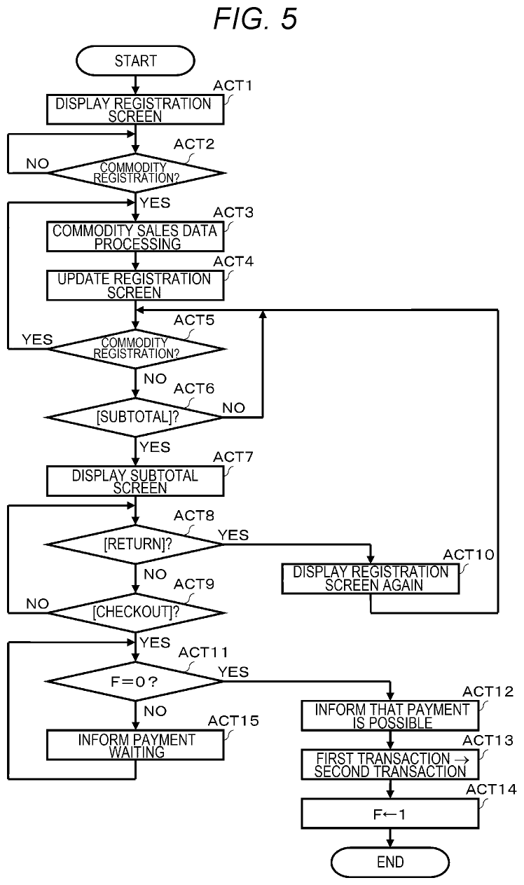

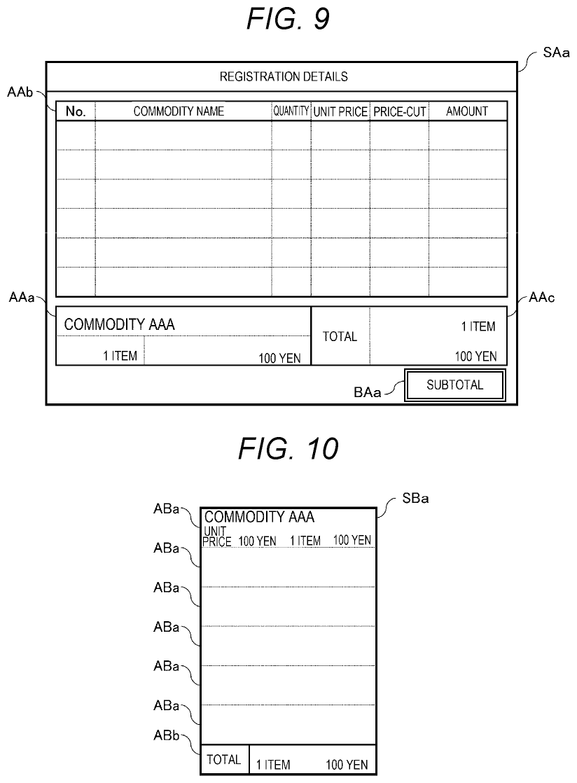

The functions of the first receiving unit 91, the second receiving unit 92, the control unit 93, the discriminating unit 94, the settling unit 95, the receipt processing unit 96, and the acquiring unit 97 explained above are implemented by information processing executed by the processor 61 according to a job program (software). Aspects of associated information processing are explained with reference to flowcharts of FIGS. 5 to 8 and various screen examples are depicted in FIGS. 9 to 26. The described procedures can be changed in various manners so long as the same effects can be achieved. The screen examples are non-limiting. Content of text to be output, arrangement of images, types and layouts of software keys (buttons), and the like can be varied as appropriate.

In this context, the job program is a type of the application program stored in the main memory 62 or the auxiliary storage device 63. The method of installing the job program in the main memory 62 or the auxiliary storage device 63 is not particularly limited. The job program can be recorded in a removable recording medium or distributed via a network and installed in the main memory 62 or the auxiliary storage device 63. A format of the recording medium generally does not matter so long as the recording medium can store the program and be read by a device like a CD-ROM, a memory card, or the like.

### Explanation of Information Processing of the Settlement Device

### First Information Processing

FIG. 5 is a flowchart illustrating a main part procedure of first information processing executed by the processor 61 of the settlement device 3 according to the job program. The customer after shopping on the selling floor moves to a checkout place. The customer places the selected commodities on the checkout counter 4 of a checkout lane PA not otherwise occupied. When the customer comes to the checkout place, the store clerk standing in the space SP touches, for example, a start button of the touch panel 23. This operation is a command for an input start in the input device 2. In other words, the operation is a command for a registration start in the settlement device 3. In response to the command, the processor 61 starts the first information processing illustrated in the flowchart of FIG. 5. In ACT 1, the processor 61 sets screens of the touch panel 23 and the display 25 in the input device 2 as registration screens.

FIG. 9 is an example of a registration screen SAa displayed on the touch panel 23. The registration screen SAa is divided into a current area AAa, a details area AAb, and a total area AAc. The current area AAa is an area for displaying a commodity name, a purchase quantity, and a sales amount of the latest purchase commodity. The details area AAb is an area where commodity names, purchase quantities, unit prices, price-cut amounts, and sales amounts of purchase commodities in one transaction are displayed in a list format in order of a series of numbers. The total area AAc is an area where a total of the purchase quantities and a total of the sales amounts for the purchased commodities are displayed. The registration screen SAa includes a subtotal button BAa. The subtotal button BAa is a software key. The subtotal button BAa is an operation piece for commanding subtotal output of purchase commodities registered by the settlement device 3 as one transaction.

FIG. 10 is an example of a registration screen SBa displayed on the display 25. In the registration screen SBa, a screen is divided into a plurality of rows (seven rows in the example illustrated in FIG. 10), a first row to the immediately preceding row of a last row are set as rows of a details area ABa, and the last row is set as a row of a total area ABb. In the rows of the details area ABa, commodity names, unit prices, purchase quantities, and sales amounts of purchase commodities are displayed row by row. In the total area ABb, a total of the purchase quantities and a total of the purchase amounts are displayed in one row.

The store clerk then scans, with the stationary scanner 21 or the handy scanner 22, a barcode attached to a commodity to be purchased that has been placed on the checkout counter 4. The barcode is scanned, whereby a commodity code of the purchased commodity is input to the settlement device 3 via the input device interface 71. If a barcode is not attached to the purchased commodity, the store clerk can cause the touch panel 23 to display a list of commodities without barcodes. The store clerk then selects the purchased commodity out of the list. The commodity code of the purchased commodity lacking a barcode is input to the settlement device 3 via the input device interface 71.

Referring back to FIG. 5, after setting the screens of the touch panel 23 and the display 25 to the registration screen SAa and the registration screen SBa, the processor 61 proceeds to ACT 2. In ACT 2, the processor 61 waits for information necessary for registration of a purchased commodity to be input. If a commodity code is input from the input device 2 via the input device interface 71, the processor 61 determines that the information necessary for registration of the purchased commodity was input. The processor 61 proceeds from ACT 2 to ACT 3. In ACT 3, the processor 61 executes commodity sales data processing. This processing is processing for reading, from the commodity master, a commodity name, a unit price, and the like of the commodity specified by the input commodity code, generating sales data of the purchased commodity including the commodity code, the commodity name, the unit price, a purchase quantity, and a sales amount, and writing the sales data in the first transaction file 81, that is, registering the sales data.

After the commodity sales data processing is ended, the processor 61 proceeds to ACT 4. In ACT 4, the processor 61 updates the registration screen SAa and the registration screen SBa.

Concerning the registration screen SAa, the processor 61 displays, in the current area AAa, the commodity name, the purchase quantity, and the sales amount of the sales data written in the first transaction file 81. At this time, if sales data of a purchased commodity, information concerning which is input immediately before the sales data is written, is displayed in the current area AAa, the processor 61 displays, in the details area AAb, a commodity name, a purchase quantity, a unit price, a price-cut amount, and a sales amount of the sales data. The processor 61 displays, in the total area AAc, totals of purchase quantities and sales amounts of all sales data stored in the first transaction file 81.

Concerning the registration screen SBa, the processor 61 displays, in a first row of the details area ABa, the commodity name, the unit price, the purchase quantity, and the sales amount of the sales data written in the first transaction file 81. At this time, if the sales data is displayed in the first row of the details area ABa, the processor 61 sequentially shifts data in the first row and the subsequent rows to a second and the subsequent rows and then displays, in the first row, the sales data written in the first transaction file 81. The processor 61 displays, in the total area ABb, totals of purchase quantities and sales amounts of all sales data stored in the first transaction file 81.

The processor 61, after updating the registration screen SAa and the registration screen SBa, proceeds to ACT 5. In ACT 5, the processor 61 checks whether information concerning the next purchase commodity was input to the input device 2. If information concerning the next purchase commodity was not input, in ACT 6, the processor 61 checks whether the subtotal button BAa was touched. If the subtotal button BAa was not touched, the processor 61 returns to ACT 5. As explained above, in ACT 5 and ACT 6, the processor 61 waits for information concerning the next purchase commodity to be input or the subtotal button BAa to be touched.

If information concerning a purchased commodity is input in the waiting state in ACT 5 and ACT 6, the processor 61 returns to ACT 3. The processor 61 executes the processing in ACT 3 and ACT 4 in the same manner as explained above.

Therefore, the store clerk operates the stationary scanner 21, the handy scanner 22, or the touch panel 23 of the input device 2 and inputs information concerning purchase commodities placed on the checkout counter 4 item by item, whereby sales data of the purchased commodities is stored in the first transaction file 81. The registration screen SAa and the registration screen SBa are updated. Upon finishing the operation for inputting the information concerning the purchased commodity to the input device 2, the store clerk touches the subtotal button BAa.

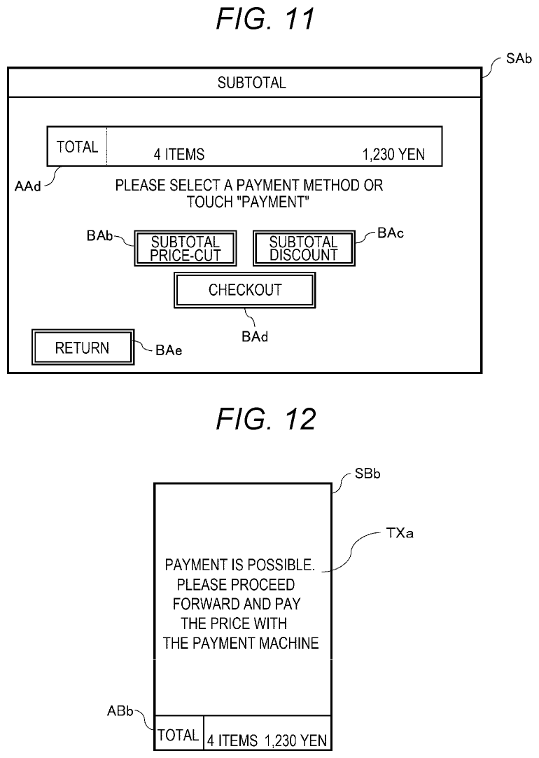

In the waiting state in ACT 5 and ACT 6, if the subtotal button BAa is touched by the store clerk, the processor 61 proceeds to ACT 7. In ACT 7, the processor 61 sets a screen of the touch panel 23 in the input device 2 as a subtotal screen SAb (see FIG. 11).

FIG. 11 is an example of the subtotal screen SAb displayed on the touch panel 23. The subtotal screen SAb includes a total area AAd where a total of purchase quantities and a total of sales amounts of purchase commodities in one transaction are displayed. The subtotal screen SAb includes a subtotal price-cut button BAb, a subtotal discount button BAc, a checkout button BAd, and a return button BAe. The buttons BAb, BAc, BAd, and BAe are software keys. The subtotal price-cut button BAb is an operation piece for commanding a price-cut of a total amount. The subtotal discount button BAc is an operation piece for commanding a discount of a total amount. The checkout button BAd is an operation piece for commanding to finish information input for a purchased commodity. The return button BAe is an operation piece for commanding to return to the information input for the purchased commodity.

The store clerk then checks whether an unregistered commodity remains on the checkout counter 4. If an unregistered commodity is present, the store clerk touches the return button BAe.

On the other hand, if there are no more commodities to be registered, the store clerk checks whether a transaction is a subtotal price-cut target transaction or a subtotal discount target transaction. For example, if the customer presents a coupon of a subtotal price-cut, the transaction is the subtotal price-cut target transaction. The store clerk touches the subtotal price-cut button BAb and inputs a price-cut amount with a ten key pad of the keyboard 24. A total amount is cut by the operation explained above. The processing explained above is referred to as subtotal price-cut processing. Similarly, for example, if the customer presents a coupon of a subtotal discount, the transaction is the subtotal discount target transaction. The store clerk touches the subtotal discount button BAc and inputs a discount rate with the ten key pad of the keyboard 24. The total amount is discounted by the operation explained above. The processing explained above is referred to as subtotal discount processing.

If there remains no unregistered commodity, and a subtotal price-cut or a subtotal discount is unnecessary, the store clerk touches the checkout button BAd.

Referring back to FIG. 5, the processor 61, after setting the screen of the touch panel 23 to the subtotal screen SAb, proceeds to ACT 8. In ACT 8, the processor 61 checks whether the return button BAe was touched. If the return button BAe was not touched, the processor 61 proceeds to ACT 9. In ACT 9, the processor 61 checks whether the checkout button BAd was touched. If the checkout button BAd was not touched, the processor 61 returns to ACT 8. As explained above, in ACT 8 and ACT 9, the processor 61, waits for the return button BAe to be touched or the checkout button BAd to be touched.

Note that, if the subtotal price-cut button BAb or the subtotal discount button BAc is touched in the waiting state in ACT 8 or ACT 9, the processor 61 performs the subtotal price-cut processing or the subtotal discount processing explained above. Thereafter, the processor 61 returns to the waiting state in ACT 8 and ACT 9.

If the return button BAe is touched by the store clerk in the waiting state in ACT 8 and ACT 9, the processor 61 proceeds from ACT 8 to ACT 10. In ACT 10, the processor 61 returns the screen of the touch panel 23 to the immediately preceding registration screen SAa. The processor 61 returns to the waiting state in ACT 5 and ACT 6. Therefore, the store clerk only has to operate the stationary scanner 21, the handy scanner 22, or the touch panel 23 of the input device 2 and input the information concerning the unregistered commodity that was not yet input.

If the checkout button BAd is touched by the store clerk in the waiting state in ACT 8 and ACT 9, the processor 61 proceeds from ACT 9 to ACT 11. In ACT 11, the processor 61 checks the payment-in-progress flag F. In a state in which payment operation for a price was not performed in the settlement device 3, the payment-in-progress flag F was reset to “0”. If the payment-in-progress flag F was reset to “0”, the processor 61 proceeds from ACT 11 to ACT 12. In ACT 12, the processor 61 sets the screen of the display 25 as a first notification screen SBb (see FIG. 12).

FIG. 12 is an example of the first notification screen SBb displayed on the display 25. The first notification screen SBb displays first text TXa together with information of the total area ABb in the registration screen SBa. The first text TXa is text including content for instructing the customer to move to a payment machine because a price can be paid. The customer then moves towards a settlement device 3 to pays the price of the registered commodities (settle the sales transaction).

Referring back to FIG. 5, the processor 61, after displaying the first notification screen SBb on the display 25, proceeds to ACT 13. In ACT 13, the processor 61 copies data stored in the first transaction file 81, that is, sales data of purchase commodities registered as one transaction to the second transaction file 82. In ACT 14, the processor 61 sets the payment-in-progress flag F of the flag memory 83 to “1”. Then, the processor 61 ends the first information processing relating to a transaction with a first customer.

The processor 61 starts the first information processing relating to a transaction with a second customer. That is, the processor 61 executes the processing in ACT 1 and subsequent acts in the same manner as explained above. At this time, it could occur that the payment-in-progress flag F set to “1” in ACT 14 of the first information processing for the first customer was not reset to “0” at a point in time of ACT 11 of the first information processing for the second customer.

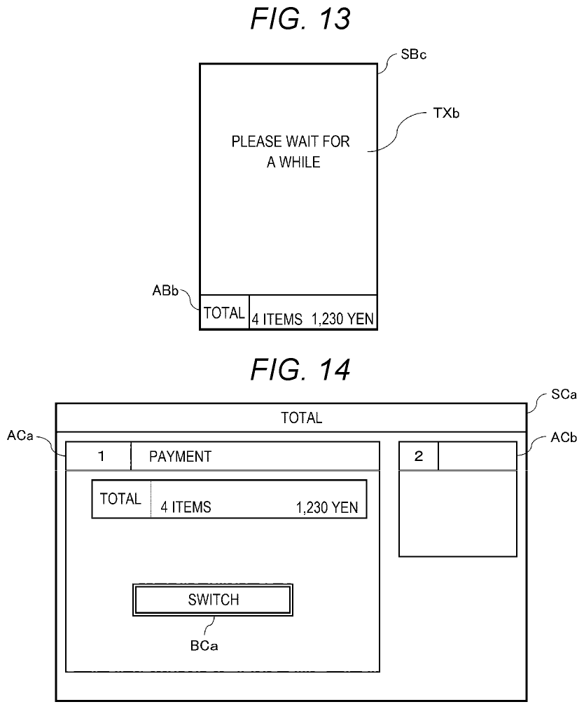

If the payment-in-progress flag F was set to “1” in ACT 11, the processor 61 proceeds from ACT 11 to ACT 15. In ACT 15, the processor 61 sets the screen of the display 25 as a second notification screen SBc (see FIG. 13).

FIG. 13 s an example of the second notification screen SBc displayed on the display 25. The second notification screen SBc displays second text TXb together with information of the total area ABb in the registration screen SBa. The second text TXb is text including content for instructing the customer to wait because the transaction cannot be completed (settled) yet. The second customer waits until payment (settlement) becomes possible.

Referring back to FIG. 5, the processor 61, after displaying the second notification screen SBc on the display 25, returns to ACT 11. In ACT 11, the processor 61 waits for the payment-in-progress flag F to be reset to “0”. The payment-in-progress flag F is reset to “0” if settlement processing is finished in second information processing explained below. If the payment-in-progress flag F is reset to “0”, the processor 61 proceeds from ACT 11 to ACT 12. The processor 61 executes the processing in ACT 12 to ACT 14 in the same manner as explained above. That is, the processor 61 displays the first notification screen SBb on the display 25. According to this display, the second customer moves in a direction in which the settlement device 3 is installed and pays a price.

The processor 61 copies data stored in the first transaction file 81 to the second transaction file 82. The processor 61 sets the payment-in-progress flag F to “1” and ends the first information processing for the second customer. Thereafter, the processor 61 subsequently repeatedly executes the first information processing as explained above for a third customer, a fourth customer, and the like.

When inputting the information concerning the purchase commodity with the input device 2, the store clerk can check with the customer whether the customer is an electronic receipt member, that is, whether the customer intends to an electronic receipt service in the present sales transaction. For example, before performing the commodity registration in ACT 1 in FIG. 5, the store clerk simply asks the customer whether the customer is an electronic receipt member. If the customer causes a smartphone or the like to display a barcode of an electronic receipt member ID and presents the barcode to the store clerk, the store clerk reads the barcode with the handy scanner 22. The processor 61 causes, for example, the main memory 62 to store data indicating the electronic receipt member ID as read by the handy scanner 22. The processor 61 updates the member flag MF from default “0” to “1” according to the acquisition of the electronic receipt member ID. Note that the reading of the electronic receipt member ID is not limited to being before the commodity registration start. For example, any time before the store clerk operates the checkout button BAd in ACT 9 in FIG. 5, the customer may indicate whether the customer is an electronic receipt member and the reading operation described above may be executed whenever the electronic receipt member ID is presented.

### Second Information Processing

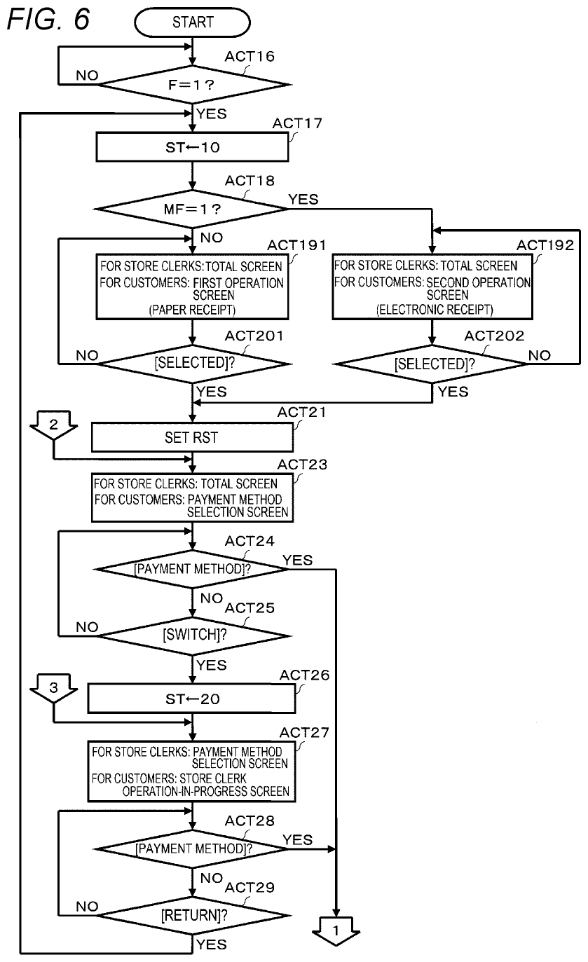

FIG. 6 and FIG. 7 are flowcharts illustrating second information processing executed by the processor 61 of the settlement device 3 according to the job program. The processor 61 executes the second information processing in parallel to the first information processing explained above.

In ACT 16, the processor 61 waits for the payment-in-progress flag F to be set to “1”. Note that, in this waiting state, initial screens are displayed on the first touch panel 32 and the second touch panel 34. Contents of the initial screens are not particularly limited. For example, the initial screen displayed on the first touch panel 32 is a screen having the same layout as a layout of a total screen SCa explained below. However, no information is displayed on the initial screen. The initial screen displayed on the second touch panel 34 is a screen on which text such as “Welcome” or an image is displayed. Alternatively, nothing may be displayed on the initial screen.

If the payment-in-progress flag F is set to “1” in ACT 14 of the first information processing, the processor 61 proceeds from ACT 16 to ACT 17. In ACT 17, the processor 61 sets the payment status ST to “10”.

In order to perform settlement, the processor 61 sequentially displays screens for selecting a receipt dispensing form and a payment method according to requests of the user (an operation screen→a payment method setting screen) and receives operations of the customer or the store clerk. In the settlement device 3 in this embodiment, the processor 61 displays the operation screen on which choices are changed according to whether the customer is an electronic receipt member and causes the customer to select a receipt dispensing form and, thereafter, displays the payment method selection screen and causes the customer to select a payment method.

First, the processor 61 refers to the member flag MF and discriminates whether the customer is an electronic receipt member. If discriminating in ACT 18 that the member flag MF is “0”, in ACT 23, the processor 61 sets the screen of the first touch panel 32 to a total screen SCa (see FIG. 14) and sets the screen of the second touch panel 34 to a first operation screen SDf1 (see FIG. 16).

If the member flag MF is “1”, in ACT 23, the processor 61 sets the screen of the first touch panel 32 to the total screen SCa (see FIG. 14) and sets the screen of the second touch panel 34 to a second operation screen SDf2 (see FIG. 17).

FIG. 14 is an example of the total screen SCa displayed on the first touch panel 32. The total screen SCa includes a first customer area ACa and a second customer area ACb. The first customer area ACa is an area for displaying information concerning the first customer who is about to settle a transaction. A total number of items and a total amount for the first customer are displayed in the first customer area ACa. That is, a total of purchased quantities and a total sales amounts calculated based on the sales data of the purchased commodities stored in the second transaction file 82 are displayed in the first customer area ACa. A switching button BCa is displayed in the first customer area ACa. The switching button BCa is a software key. The switching button BCa is an operation piece for declaring that the store clerk intervenes in payment operation for a price.

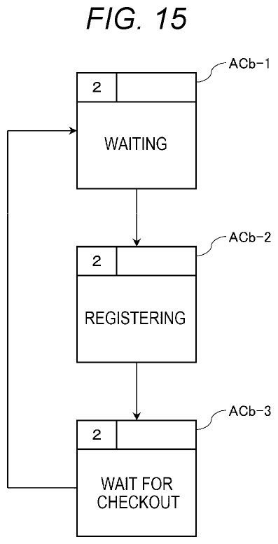

The second customer area ACb is an area for displaying information concerning the second customer. An example of the information displayed in the second customer area ACb is illustrated in FIG. 15. FIG. 15 is a schematic diagram illustrating a transition example of the information displayed in the second customer area ACb.

In a state in which information input for a commodity to be purchased by the second customer is not started yet in the input device 2, “waiting” is displayed, for example, as illustrated in a second customer area ACb-1. If the information input for the commodity to be purchased by the second customer is started, “registering” is displayed, for example, as illustrated in a second customer area ACb-2. If the information input for the commodity to be purchased by the second customer is completed, “waiting for checkout” is displayed, for example, as illustrated in a second customer area ACb-3. Thereafter, if checkout for the first customer is completed and is shifted to checkout for the second customer, the display returns to “waiting” as illustrated in the second customer area ACb-1. Note that nothing may be displayed in the second customer area ACb-1.

As explained above, the information displayed in the first customer area ACa of the total screen SCa is an area for displaying information concerning the first customer about to pay a price. The information displayed in the second customer area ACb of the total screen SCa is an area for displaying information concerning the second customer who will settle a transaction after the first customer (whose information is displayed in the first customer area Aca). That is, the total screen SCa can be considered a screen for displaying information concerning any customer before settlement.

FIG. 16 is an example of the first operation screen SDf1 displayed on the second touch panel 34. Three choices (buttons BDr1 to BDr3) are provided on the first operation screen SDf1 as receipt dispensing forms that can be designated by selection operation by the customer. The button BDr1 is for instructing output of a standard (general) paper receipt. The button BDr2 is for instructing no output of a paper receipt. The button BDr3 is for instructing output of a handwritten receipt on a paper medium instead of the output of the standard paper receipt.

Since a button for specifically requesting output of a receipt is provided on the first operation screen SDf1, a customer who is not an electronic receipt member may still be required to explicitly decide whether to get a receipt or not. Therefore, it is possible to eliminate output of unnecessary receipts and prevent useless consumption of paper resources and increases in waste. Since the button BDr3 for instructing output of a handwritten receipt is also provided, it is possible for a customer requiring a handwritten receipt to request output of a handwritten receipt instead of a standard paper receipt.

FIG. 17 is an example of the second operation screen SDf2 displayed on the second touch panel 34. Two choices (buttons BDr4 and BDr5) are provided on the second operation screen SDf2 as receipt dispensing options that can be designated by selection operation by the customer. The button BDr4 is for instructing output of an electronic receipt. The button BDr5 is for instructing output of a handwritten receipt on a paper medium.

Since the button BDr4 for requesting an electronic receipt is provided on the second operation screen SDf2, the customer who is an electronic receipt member can request an electronic receipt. That is, it is possible to clearly indicate that a paper receipt is unnecessary. Consequently, when the customer uses an electronic receipt service, the customer will not be confused by selection operation options for output of a receipt.

Since the button BDr5 for selecting a handwritten receipt is provided, a customer wanting a handwritten receipt in addition to, or instead of, an electronic receipt can request output of a handwritten receipt.

In ACT 21, the processor 61 sets the receipt dispensing format status RST according to selection by the customer on the first operation screen SDf1 or the second operation screen SDf2. That is, the processor 61 sets “01” indicating a paper receipt request if the button BDr1 is selected on the first operation screen, sets “02” indicating output of a paper receipt is unnecessary if the button BDr2 is selected on the first operation screen, and sets “03” indicating a handwritten receipt request if the button BDr3 is selected on the first operation screen. The processor 61 sets “11” representing an electronic receipt if the button BDr4 is selected on the second operation screen and sets “13” representing a handwritten receipt (in addition to the electronic receipt) if the button BDr4 is selected on the second operation screen.

The set receipt dispensing format status RST is referred to in receipt output processing in ACT 44 in FIG. 7 explained below. Processing concerning a receipt corresponding to a set status is executed.

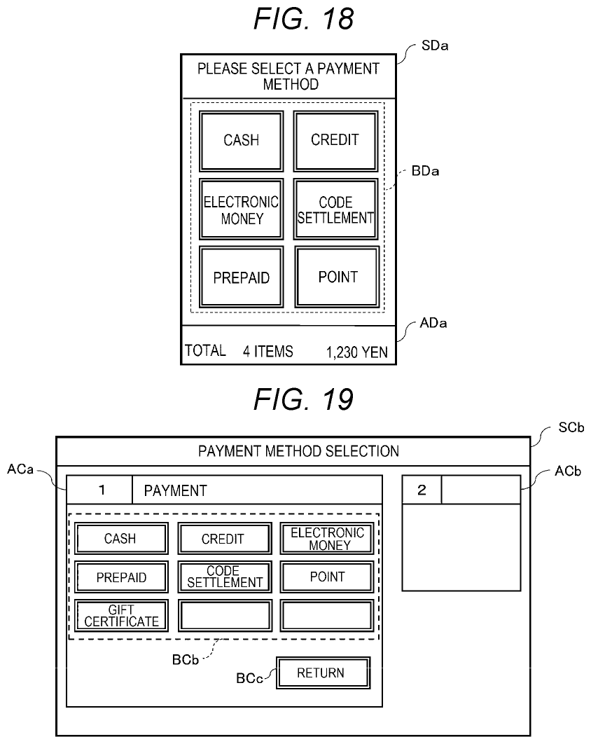

FIG. 18 is an example of a payment method selection screen SDa displayed on the second touch panel 34. The payment method selection screen SDa includes a payment method selection button group BDa. The payment method selection button group BDa includes a cash button, a credit button, an electronic money button, a code settlement button, a prepaid button, and a point button. All of the cash button, the credit button, the electronic money button, the code settlement button, the prepaid button, and the point button are software keys.

The payment method selection screen SDa includes a total area ADa. A total number of items and a total amount of a customer about to make payment are displayed in the total area ADa. That is, a total of purchase quantities and a total of sales amounts calculated based on the sales data of the purchased commodities stored in the second transaction file 82 are displayed in the total area ADa.

The customer, who checked the payment method selection screen SDa, touches a button of a desired payment method out of the payment method selection button group BDa. For example, a customer desiring to pay by cash touches the cash button. A customer desiring to pay by a credit card touches the credit button. A customer desiring to pay by electronic money touches the electronic money button. A customer desiring to pay by code settlement touches the code settlement button. A customer desiring to pay by a prepaid card touches the prepaid button. A customer desiring to pay by a cumulative point touches the point button.

Referring back to FIG. 6, the processor 61, after setting the screen of the first touch panel 32 to the total screen SCa and the second touch panel 34 to the payment method selection screen SDa, proceeds to ACT 24. In ACT 24, the processor 61 checks whether one button of the payment method selection button group BDa displayed on the payment method selection screen SDa was touched. If a button of the payment method selection button group BDa was not touched, the processor 61 proceeds to ACT 25. In ACT 25, the processor 61 checks whether the switching button BCa displayed on the total screen SCa was touched. If the switching button BCa of the total screen SCa was not touched either, the processor 61 returns to ACT 24. As explained above, in ACT 24 and ACT 25, the processor 61 waits for a button of the payment method selection button group BDa in the payment method selection screen SDa to be touched or the switching button BCa of the total screen SCa to be touched.

If a button of the payment method selection button group BDa is touched by the customer in the waiting state in ACT 24 and ACT 25, the processor 61 proceeds from ACT 24 to ACT 30 in FIG. 7. Processing in ACT 30 and subsequent acts is explained below.

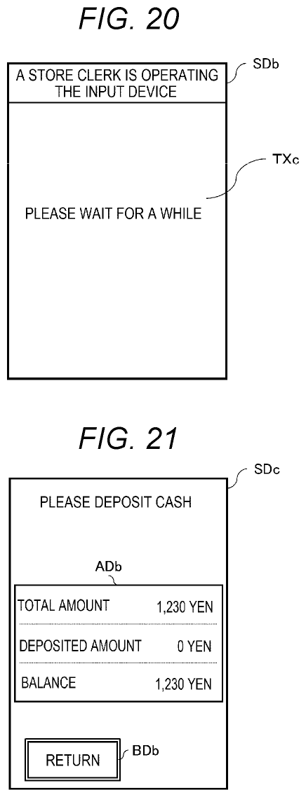

If the switching button BCa is touched by the store clerk in the waiting state in ACT 24 and ACT 25, the processor 61 proceeds from ACT 25 to ACT 26. In ACT 26, the processor 61 sets the payment status ST to “20”. In ACT 27, the processor 61 sets the screen of the first touch panel 32 to a payment method selection screen SCb (see FIG. 19) and sets the screen of the second touch panel 34 to a store clerk operation-in-progress screen SDb (see FIG. 20).

FIG. 19 is an example of the payment method selection screen SCb displayed on the first touch panel 32. In the payment method selection screen SCb, a payment method selection button group BCb and a return button BCc are disposed in the first customer area ACa of the total screen SCa. The second customer area ACb of the total screen SCa is displayed in the same manner on the payment method selection screen SCb.

The payment method selection button group BCb includes a gift certificate button in addition to the cash button, the credit button, the electronic money button, the code settlement button, the prepaid button, and the point button explained above. The gift certificate button is also a software key. If a price is paid by a gift certificate, the store clerk needs to intervene in order to check validity of the gift certificate. Therefore, the gift certificate button is not included in the payment method selection screen SDa of the second touch panel 34, the operator of which is the customer. However, the gift certificate button is included in the payment method selection screen SCb of the first touch panel 32, the operator of which is the store clerk. The return button BCc is a software key. The return button BCc is an operation piece for declaring to return the payment method selection screen SCb to the immediately preceding screen, that is, the total screen SCa.

FIG. 20 is an example of the store clerk operation-in-progress screen SDb displayed on the second touch panel 34. As illustrated in FIG. 20, third text TXc for notifying the customer that the store clerk is in operation is displayed on the store clerk operation-in-progress screen SDb. Note that an image indicating that the store clerk is in operation may be displayed instead of the third text TXc. Alternatively, the third text TXc and the image may be displayed together. In short, it is sufficient if the customer can be notified that the store clerk is in operation.

Referring back to FIG. 6, the processor 61, after setting the screen of the first touch panel 32 to the payment method selection screen SCb and the second touch panel 34 to the store clerk operation-in-progress screen SDb, proceeds to ACT 28. In ACT 28, the processor 61 checks whether a button of the payment method selection button group BCb on the payment method selection screen SCb was touched. If a button of the payment method selection button group BCb was not touched, the processor 61 proceeds to ACT 29. In ACT 29, the processor 61 checks whether the return button BCc of the payment method selection screen SCb was touched. If the return button BCc was not touched either, the processor 61 returns to ACT 28. As explained above, in ACT 28 and ACT 29, the processor 61 waits for a button of the payment method selection button group BCb to be touched or the return button BCc to be touched.

If a button of the payment method selection button group BCb is touched by the store clerk in the waiting state in ACT 28 and ACT 29, the processor 61 proceeds from ACT 28 to ACT 30 in FIG. 7. Processing in ACT 30 and subsequent acts is explained below.

If the return button BCc is touched by the store clerk in the waiting state in ACT 28 and ACT 29, the processor 61 returns from ACT 29 to ACT 17. That is, the processor 61 sets the payment status ST to “10” and executes the same processing as the processing explained above.

If a button of the payment method selection button group BDa displayed on the second touch panel 34 is touched by the customer in ACT 24 or a button of the payment method selection button group BCb displayed on the first touch panel 32 is touched by the store clerk in ACT 28 as explained above, the processor 61 proceeds to ACT 30 in FIG. 7. In ACT 30, the processor 61 sets the screen of the first touch panel 32 to the total screen SCa (see FIG. 14) and sets the screen of the second touch panel 34 to a payment support screen SDc (see FIG. 21).

FIG. 21 is an example of the payment support screen SDc displayed on the second touch panel 34. FIG. 21 illustrates the payment support screen SDc displayed if the cash button of the payment method selection button group BDa or the payment method selection button group BCb is touched. The payment support screen SDc includes a change machine information area ADb. A return button BDb is disposed on the payment support screen SDc.

A total amount, a deposited amount, that is, an amount of cash deposited to the automatic change machine 36, the balance obtained by subtracting the deposited amount from the total amount are displayed in the change machine information area ADb. The return button BDb is a software key. The return button BDb is an operation piece for instructing to suspend payment by a selected payment method.

Referring back to FIG. 7, the processor 61, after setting the first touch panel 32 to the total screen SCa and the second touch panel 34 to the payment support screen SDc, proceeds to ACT 31. In ACT 31, the processor 61 checks whether a price was deposited. If the price was not deposited, the processor 61 proceeds to ACT 32. In ACT 32, the processor 61 checks whether the return button BDb was touched. If the return button BDb was not touched, the processor 61 returns to ACT 31. As explained above, in ACT 31 and ACT 32, the processor 61 waits for a price to be deposited or the return button BDb to be touched.

The customer, who selected the cash payment as the price payment method, deposits cash to the automatic change machine 36. The customer, who selected the credit card payment, causes a reader of the cashless settlement terminal 37 to read data of a credit card. The customer, who selected the electronic money payment, causes the reader of the cashless settlement terminal 37 to read data of an electronic money medium. The customer, who selected the code settlement payment, causes a scanner of the cashless settlement terminal 37 to read a barcode or a two-dimensional data code for code settlement. The customer desiring the prepaid card payment causes the reader of the cashless settlement terminal 37 to read data of a prepaid card. The customer desiring the point payment causes the reader of the cashless settlement terminal 37 to read data of a point card. If the payment operation by the customer explained above was performed, in ACT 31, the processor 61 determines that the price was deposited.

The processor 61, after the price is deposited, proceeds from ACT 31 to ACT 33. In ACT 33, the processor 61 executes payment processing. For example, if cash payment was selected, the processor 61 deducts an amount of cash deposited to the automatic change machine 36 from the total amount. If the credit card payment was selected, the processor 61 authenticates a credit card. If the electronic money payment was selected, the processor 61 deducts the total amount from the balance of electronic money. If the code settlement payment was selected, the processor 61 deducts the total amount from the balance of code settlement. If the prepaid card payment was selected, the processor 61 deducts the total amount from the balance of a prepaid card. If the point payment was selected, the processor 61 deducts the total amount from an amount equivalent to a cumulative point.

The processor 61 then proceeds to ACT 34. In ACT 34, the processor 61 determines whether the payment was completed. For example, if the amount of the cash deposited to the automatic change machine 36 was insufficient for the total amount, the processor 61 determines that the payment is incomplete. Similarly, if failing in authenticating the credit card or if the balance of the electronic money, the code settlement, the prepaid card, the cumulative points total, or the like is insufficient for the total amount due, the processor 61 determines that the payment is incomplete. If the payment is incomplete, the processor 61 returns to ACT 31. In ACT 31 and ACT 32, the processor 61 waits for payment to be made again or the return button BDb to be touched.

In a state in which the payment is incomplete, that is, in the waiting state in ACT 31 and ACT 32, the customer can change the payment method to another method. For example, if the cash payment was selected but cash on hand is insufficient, the customer can change the payment method to a payment method other than the cash. The customer desiring to change the payment method to another payment method touches the return button BDb.

If the return button BDb was touched by the customer in the waiting state in ACT 31 and ACT 32, the processor 61 proceeds from ACT 32 to ACT 35. In ACT 35, the processor 61 checks whether the return button BDb was touched after the cash was deposited to the automatic change machine 36. If the return button BDb was touched after the cash was deposited to the automatic change machine 36, the processor 61 proceeds to ACT 36. In ACT 36, the processor 61 stores the amount of the cash deposited to the automatic change machine 36, a so-called deposit amount in the main memory 62. If cash was not deposited to the automatic change machine 36 and the return button BDb was touched, the processor 61 skips the processing in ACT 36.

After executing or skipping the processing in ACT 36, the processor 61 proceeds to ACT 37. In ACT 37, the processor 61 checks the status ST. Note that, at this point in time, the status ST can be “10” or “20”.

If the status ST is “10”, the processor 61 returns to ACT 23 in FIG. 6. That is, the processor 61 sets the screen of the first touch panel 32 to the total screen SCa (see FIG. 14) and sets the screen of the second touch panel 34 to the payment method selection screen SDa (see FIG. 18). As explained above, when the customer touches the return button BDb while in the status ST of “10”, the payment method selection screen SDa is displayed on the second touch panel 34. Therefore, the customer only has to touch a button of a desired payment method out of the payment method selection button group BDa again.

If the status ST is “20”, the processor 61 returns to ACT 27 in FIG. 6. That is, the processor 61 sets the screen of the first touch panel 32 to the payment method selection screen SCb (see FIG. 19) and sets the screen of the second touch panel 34 to the store clerk operation-in-progress screen SDb (see FIG. 20). As explained above, if the customer touches the return button BDb in the status ST of “20”, the payment method selection screen SCb is displayed on the first touch panel 32. Therefore, the store clerk only has to touch the button of the payment method desired by the customer out of the payment method selection button group BCb again.

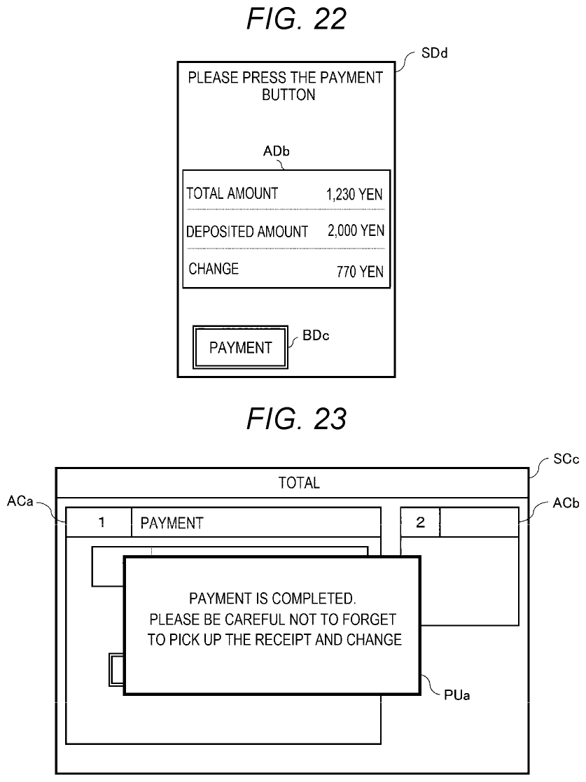

The processor 61, after recognizing in ACT 34 that the payment was completed, proceeds to ACT 38. In ACT 38, the processor 61 sets the screen of the first touch panel 32 to the total screen SCa (see FIG. 14) and sets the screen of the second touch panel 34 to a payment check screen SDd (see FIG. 22).

FIG. 22 is an example of the payment check screen SDd displayed on the second touch panel 34. FIG. 22 illustrates the payment check screen SDd displayed if the cash button of the payment method selection button group BDa or the payment method selection button group BCb is touched. The payment check screen SDd includes the change machine information area ADb. In the change machine information area ADb, a difference obtained by subtracting the deposited amount from the total amount is displayed as the balance on the payment support screen SDc but a difference obtained by subtracting the total amount from the deposited amount is displayed as a change amount on the payment check screen SDd. A payment button BDc is disposed on the payment check screen SDd. The return button BDb disposed on the payment support screen SDc is not disposed on the payment support screen SDc. The payment button BDc is an operation piece for declaring that the payment was completed. The customer, who finished the payment of the price, touches the payment button BDc.

Referring back to FIG. 7, the processor 61, after setting the first touch panel 32 to the total screen SCa and the second touch panel 34 to the payment check screen SDd, proceeds to ACT 39. In ACT 39, the processor 61 waits for the payment button BDc to be touched. If the payment button BDc is touched by the customer, the processor 61 proceeds to ACT 40. In ACT 40, the processor 61 checks whether a deposit amount was stored. If a deposit amount was stored in the processing in ACT 36, the processor 61 proceeds to ACT 41. In ACT 41, the processor 61 controls the automatic change machine 36 such that cash equivalent to the deposit amount is dispensed. If a deposit amount was not stored in the processing in ACT 36, the processor 61 skips the processing in ACT 41.

After executing or skipping the processing in ACT 41, the processor 61 proceeds to ACT 42. In ACT 42, the processor 61 checks whether change is present. If change is present because cash payment was selected as the payment method and cash of an amount exceeding the total amount was deposited to the automatic change machine 36, the processor 61 proceeds to ACT 43. In ACT 43, the processor 61 controls the automatic change machine 36 such that cash equivalent to a change amount is dispensed. If change is not present, the processor 61 skips the processing in ACT 43.

After executing or skipping the processing in ACT 43, the processor 61 proceeds to ACT 44. In ACT 44, the processor 61 executes receipt output processing.

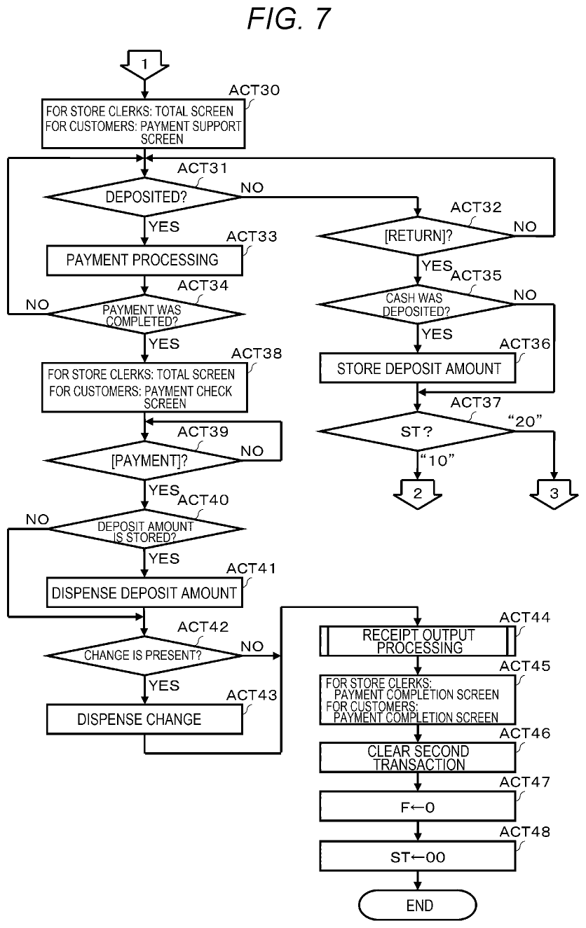

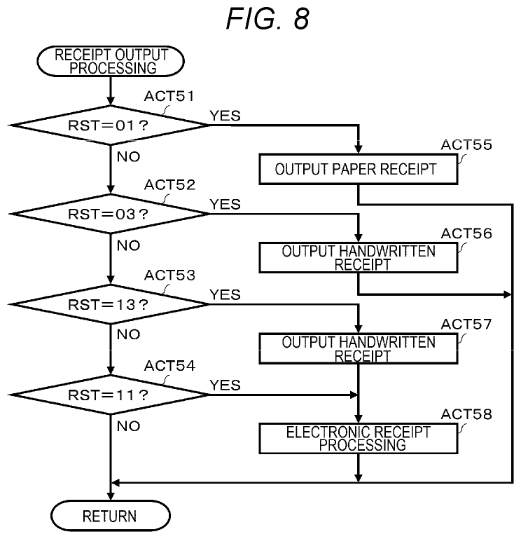

FIG. 8 is a flowchart of receipt output processing executed by the processor 61 of the settlement device 3 according to the job program.

The processor 61 checks the receipt dispensing format status RST and executes processing for receipt output corresponding to the receipt dispensing format status RST. If the receipt dispensing form status RST is “01” in ACT 51, the processor 61 causes the printer 35 to output a paper receipt in ACT 55. That is, the processor 61 generates receipt data indicating details of a commercial transaction based on the sales data and the like stored in the second transaction file 82. The processor 61 outputs the receipt data to the printer 35. Consequently, the printer 35 operates and prints and dispenses the paper receipt.

If the receipt dispensing format status RST is “02”, the processor 61 ends the receipt output processing without outputting a receipt since this status indicates output of a paper receipt is unnecessary.

In ACT 52 if the receipt dispensing format status RST is “03”, the processor 61 causes the printer 35 to output a handwritten receipt in ACT 56. That is, the processor 61 generates handwritten receipt data based on the sales data and the like stored in the second transaction file 82. The processor 61 outputs the handwritten receipt data to the printer 35. Consequently, the printer 35 prints the handwritten receipt on a paper medium and dispenses the handwritten receipt.

In ACT 53, if the receipt dispensing format status RST is “13”, the processor 61 causes the printer 35 to output a handwritten receipt in ACT 57. Next, in ACT 58, the processor 61 causes the printer 35 to execute electronic receipt processing for outputting an electronic receipt. That is, the processor 61 transmits receipt data to the management server 8 together with an electronic receipt ID of the customer. Consequently, the customer can acquire electronic receipt data using the electronic receipt service by operating a smartphone. In this way, if a customer who is registered as an electronic receipt member selects a handwritten receipt as a receipt dispensing form, it is possible to dispense a handwritten receipt by a paper medium and also output electronic receipt data. Note that, in some examples, if the handwritten receipt was selected as the receipt dispensing form, then only the handwritten receipt may be dispensed and an electronic receipt may not be dispensed. Consequently, the customer can receive, upon request, a paper medium that proves purchase. It is thus possible to prevent unwanted paper receipts from dispensing from the settlement device 3.

Note that the processor 61 may transmit the sales data stored in the second transaction file 82 to the electronic receipt management server 8 connected to the settlement device 3 together with the electronic receipt ID and cause the electronic receipt management server 8 to execute the electronic receipt processing for outputting an electronic receipt based on the sales data transmitted from the processor 61. In other words, the electronic receipt processing may be executed in a device different from the settlement device 3.

If, in ACT 54, the receipt dispensing format status RST is “11”, the processor 61 causes the printer 35 to execute the electronic receipt processing for outputting an electronic receipt in ACT 58 in the same manner as explained above. In this way, if the customer is registered as an electronic receipt member and selects an electronic receipt as the only receipt dispensing form, it is possible to dispense just the electronic receipt without dispensing any paper receipt.

Note that, in the above explanation, if in ACT 53 the receipt dispensing format status RST is “13”, that is, if the handwritten receipt is selected as the receipt dispensing form, both the handwritten receipt and the electronic receipt are dispensed (ACT 57 and ACT 58). However, in other examples, only the handwritten receipt may need to be dispensed. Whether to dispense both the handwritten receipt and the electronic receipt or dispense only the handwritten receipt may be set in advance. An output form for the RST status may be determined according to this setting.

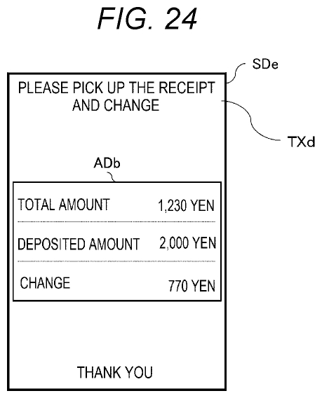

The processor 61 that performed the receipt output processing then proceeds to ACT 45. In ACT 45, the processor 61 sets the screen of the first touch panel 32 to a payment completion screen SCc (see FIG. 23) and sets the screen of the second touch panel 34 to a payment completion screen SDe (see FIG. 24).

FIG. 23 is an example of the payment completion screen SCc displayed on the first touch panel 32. In the payment completion screen SCc, a pop-up window PUa for notifying the store clerk that payment was completed is displayed over the total screen SCa. Since the pop-up window PUa is displayed, the store clerk recognizes that payment of the customer was completed in the settlement device 3.

FIG. 24 is an example of the payment completion screen SDe displayed on the second touch panel 34. FIG. 24 illustrates the payment completion screen SDe displayed if the cash button of the payment method selection button group BDa or the payment method selection button group BCb is touched. The payment completion screen SDe displays, together with the change machine information area ADb, fourth text TXd for informing the customer not to forget to pick up the receipt and the change. Note that, if the receipt is dispensed as the electronic receipt, the fourth text TXd is changed to, for example, “Please pick up the change. Please check the receipt on the electronic receipt”. If a paper receipt is dispensed from the printer 35, the customer, who checked the content displayed on the payment completion screen SDe, receives the paper receipt. If cash or change is dispensed from the automatic change machine 36, the customer receives the cash or change.

Note that FIGS. 23 and 24 illustrate display examples when a paper receipt is dispensed. However, the displays can be changed according the receipt dispensing format status RST or the like. That is, if a handwritten receipt was requested and dispensed, “handwritten receipt” can be displayed instead of “receipt”. If an electronic receipt was requested and dispensed, text indicating that the electronic receipt was dispensed can be displayed. If no paper receipt is dispensed, text clearly indicating that a receipt was not dispensed may be displayed to notify the customer to that effect. Consequently, the customer can recognize that the receipt output processing corresponding to the user selection by the customer was executed.

Referring back to FIG. 7, the processor 61, after setting the screen of the first touch panel 32 to the payment completion screen SCc and the second touch panel 34 to the payment completion screen SDe, proceeds to ACT 46. In ACT 46, the processor 61 clears the second transaction file 82. In ACT 47, the processor 61 resets the payment-in-progress flag F to “0”. In ACT 48, the processor 61 sets the payment status ST to “00”. Then, the processor 61 ends the second information processing. Consequently, price payment of the first customer is processed in the settlement device 3. If the payment-in-progress flag F is set to “1” in ACT 14 in FIG. 5 again, the processor 61 repeatedly executes the second information processing explained above. Consequently, price payment of the second customer is processed in the settlement device 3. Thereafter, price payment of a third customer, a fourth customer, and the like is processed in order in the settlement device 3.

If the payment status ST is “10”, that is, in a state in which the total screen SCa is displayed on the first touch panel 32 and the payment method selection screen SDa is displayed on the second touch panel 34 the processor 61 determines that input of a payment key in the keyboard 31 is an error. Therefore, even if the store clerk operates the payment key, the key operation is disabled.

The processor 61 implements the function of the first receiving unit 91 with the processing in ACT 51. The processor 61 implements the function of the control unit 93 with the processing in ACT 52.

### Explanation of Screen Transition of the Settlement Device

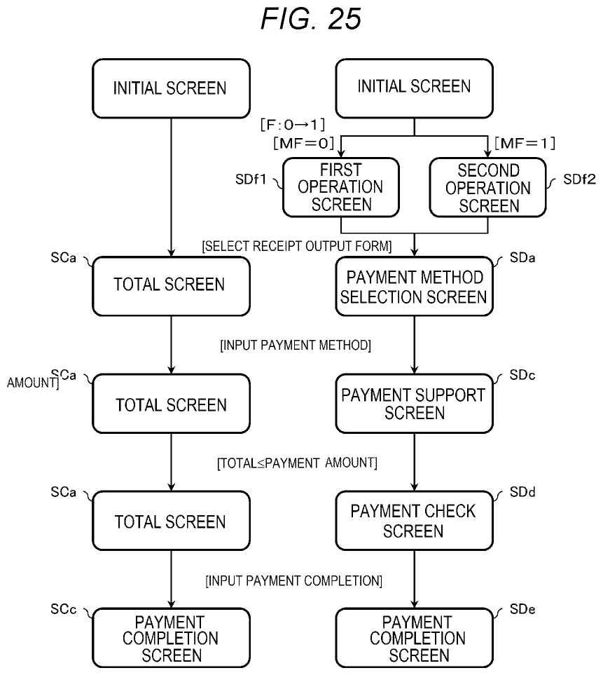

FIG. 25 illustrates transition of screens respectively displayed on the first touch panel 32 and the second touch panel 34 if the customer completes the selection operation for a receipt dispensing form and the payment operation for a price by himself or herself. The transition of the screens illustrated in FIG. 25 is executed by the processor 61 controlling the first touch panel 32 and the second touch panel 34.

First, in a situation in which the payment-in-progress flag F is “0”, that is, the settlement processing is not performed at the settlement device 3, initial screens are respectively displayed on the first touch panel 32 and the second touch panel 34.

If the checkout button BAd of the subtotal screen SAb displayed on the touch panel 23 of the input device 2 is touched by the store clerk, the payment-in-progress flag F is set to “1”.At this time, the screen of the first touch panel 32 transitions from the initial screen to the total screen SCa.

The screen of the second touch panel 34 transitions from the initial screen to the first operation screen SDf1 if the member flag MF is “0” and transitions from the initial screen to the second operation screen SDf2 if the member flag MF is “1”. Therefore, the customer moved to the side of settlement device 3 touches a desired button on the first operation screen SDf1 or the second operation screen SDf2 and selects a receipt dispensing form.

If the receipt dispensing form is selected, the screen of the second touch panel 34 transitions to the payment method selection screen SDa. Following the selection of the receipt dispensing form, the customer finds a button of a desired payment method out of the payment method selection button group BDa displayed on the payment method selection screen SDa. Then, the customer touches the button.

If the button of the payment method selection button group BDa is touched, the screen of the second touch panel 34 transitions from the payment method selection screen SDa to the payment support screen SDc. The screen of the first touch panel 32 does not transition from the total screen SCa. The customer checked the payment support screen SDc performs payment operation for a price with the selected payment method according to content displayed on the screen SDc. For example, if selecting the cash payment, the customer deposits cash to the automatic change machine 36.

As a result, if the payment of the price is completed, the screen of the second touch panel 34 transitions from the payment support screen SDc to the payment check screen SDd. The screen of the first touch panel 32 does not transition from the total screen SCa. The customer checked the payment check screen SDd touches the payment button BDc of the screen SDd. On the other hand, since the screen of the first touch panel 32 does not change from the total screen SCa, the store clerk can recognize that the customer is still paying the price. If the next customer is present, the store clerk performs, on the input device 2, information input operation for a commodity to be purchased by the customer.

When the payment button BDc is touched, the screen of the second touch panel 34 transitions from the payment check screen SDd to the payment completion screen SDe. The screen of the first touch panel 32 also transitions from the total screen SCa to the payment completion screen SCc. The store clerk checked the payment completion screen SCc can recognize that the customer finished the payment of the price.

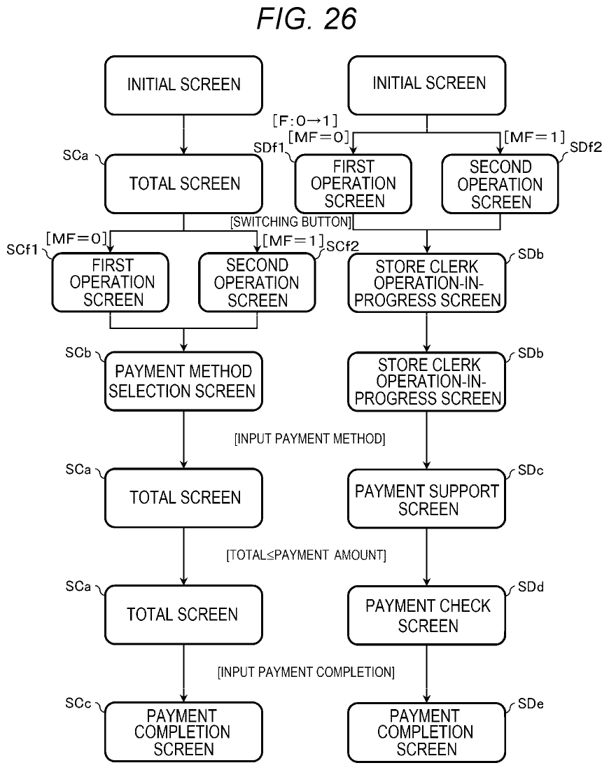

FIG. 26 is a diagram for explaining screen transition of the first touch panel 32 and the second touch panel 34 in the case in which the store clerk selects a receipt dispensing form and a price payment method in place of the customer. The transition of the screens illustrated in FIG. 26 is also executed by the processor 61 controlling the first touch panel 32 and the second touch panel 34.

In the flowchart of FIG. 6, in the processing in ACT 18 to ACT 21, a receipt dispensing form is selected by the operation of the customer and, for a price payment method, the payment method selection screen is switched to the display of the first touch panel 32 to enable the store clerk to select a price payment method in place of the customer. In FIG. 26, a case in which the store clerk selects both a receipt dispensing form and a price payment method is explained. The processing is the same as the processing illustrated in FIG. 25 until the screen of the first touch panel 32 transitions from the initial screen to the total screen SCa and the screen of the second touch panel 34 transitions from the initial screen to the operation screen (the first operation screen SDf1 or the second operation screen SDf2).

For example, if the customer takes too long of a time in operation of the first operation screen SDf1 or the second operation screen SDf2, the store clerk touches the switching button BCa of the total screen SCa. Then, the screen of the first touch panel 32 transitions from the total screen SCa to a first operation screen SCf1 or a second operation screen SCf2. Note that the first operation screen SCf1 or the second operation screen SCf2 includes the same choices (buttons) as the choices (the buttons) included in the first operation screen SDf1 and the second operation screen SDf2 illustrated in FIGS. 16 and 17. The screen of the second touch panel 34 transitions from the first operation screen SDf1 or the second operation screen SDf2 to the store clerk operation-in-progress screen SDb. The store clerk checks the receipt dispensing form with the customer according to the operation screen displayed on the screen of the first touch panel 32. The store clerk touches a button of the receipt dispensing form designated by the customer out of the buttons displayed on the first operation screen SCf1 or the second operation screen SCf2.

After the receipt dispensing form is selected, the screen of the first touch panel 32 transitions to the payment method selection screen SCb. Following the selection of the receipt dispensing form, the store clerk finds a button of a desired payment method out of the payment method selection button group BCb displayed on the payment method selection screen SCb. The store clerk touches the button.

If the store clerk touches the button of the payment method, the screen of the first touch panel 32 transitions from the payment method selection screen SCb to the total screen SCa. The screen of the second touch panel 34 transitions from the store clerk operation-in-progress screen SDb to the payment support screen SDc. Therefore, the customer can perform a payment operation using the desired payment method according to content displayed on the payment support screen SDc. Thereafter, the screens of the first touch panel 32 and the second touch panel 34 transition in the same manner as illustrated in FIG. 25.

As illustrated in FIG. 25, if the payment method selection screen SDa is displayed on the second touch panel 34, the total screen SCa is displayed on the screen of the first touch panel 32. Therefore, only the customer can perform the operation for selecting a payment method. After a payment method is selected, the screen of the second touch panel 34 transitions to the payment support screen SDc. Once the payment is completed, the screen of the second touch panel 34 transitions to the payment completion screen SDe. Therefore, the customer can completely perform the payment operation by himself or herself by sequentially following the displayed screens.

As illustrated in FIG. 26, when the store clerk touches the switching button BCa of the total screen SCa, the first operation screen SCf1 or the second operation screen SCf2 is displayed on the first touch panel 32. After a receipt dispensing form is selected, the payment method selection screen SCb is displayed on the first touch panel 32. The screen of the second touch panel 34 transitions to the store clerk operation-in-progress screen SDb. Therefore, only the store clerk can perform operation for selecting a receipt dispensing form and a payment method. At this time, since the screen of the second touch panel 34 is the store clerk operation-in-progress screen SDb, the customer can not perform operations on the screen. Therefore, in the settlement device 3, the store clerk can easily intervene in the selection of a receipt dispensing format or in the payment operation without confusion. In addition, since the screen of the second touch panel 34 is the store clerk operation-in-progress screen SDb when the store clerk intervenes, the customer can easily recognize that the store clerk intervenes.

The settlement device 3 may be capable of selecting a payment method with a payment key disposed on the keyboard 31. However, input via the payment key is generally enabled only if the payment status ST is “20”, that is, if the payment method selection screen SCb is being displayed on the first touch panel 32. Therefore, if the customer is about to perform operations for selecting a payment method, the store clerk will not be able to input a selection via a payment key by mistake. Accordingly, it is possible to provide a settlement device 3 in which trouble by erroneous operation of the store clerk does not occur and the customer can handle settlement processing by himself or herself.

### Other Embodiments

In an embodiment, the screen of the second touch panel 34 is set to the store clerk operation-in-progress screen SDb while the payment method selection screen SCb is displayed on the first touch panel 32. However, in other examples, the screen of the second touch panel 34 does not always need to be set to the store clerk operation-in-progress screen SDb. For example, the payment method selection screen SDa may be erased (blanked) from the second touch panel 34. Simply by erasing the payment method selection screen SDa in this way, it is possible to achieve an effect by which the store clerk can easily intervene in a payment operation without confusion since the customer can not operate the screen of the second touch panel 34 by mistake while the store clerk intervenes.

Information displayed in the first customer area ACa of the total screen SCa is not limited to the total number of items and the total amount of the first customer. Information displayed in the current area AAa, the details area AAb, and the total area AAc of the registration screen SAa displayed on the touch panel 23 of the input device 2 may be displayed in the first customer area ACa of the total screen SCa. Consequently, the store clerk can easily check detailed information of the first customer before settlement. Information displayed in the second customer area ACb is not limited to the information illustrated in FIG. 14. For example, during registration, the number of registered items and a total amount up to the present point in time can be displayed. At the time of checkout waiting, a total number of items and a total amount are displayed. Consequently, the store clerk can check detailed information for the second customer before settlement as well.

In an embodiment, the switching button BCa is disposed on the total screen SCa. However, the switching button BCa need not be so disposed. That is, only the customer may be able to perform selection operation for a payment method. Even in that case, similar effects to those of an embodiment with respect to certain aspects may still be achieved.

The settlement device 3 illustrated in FIG. 1 provides information based on a commodity code or the like of which is input via the input device 2, sales data of the purchased commodity and registers the sales data. In another type settlement device, the keyboard 31, the first touch panel 32, or the handy scanner 33, may be used by a store clerk as an input device. The settlement device receives information (e.g., a commodity code) concerning a purchased commodity via the input device, generates sales data of the purchased commodity based on the received information, and registers the sale data accordingly. However, the customer himself or herself pays the price necessary for settlement of the transaction by operating the second touch panel 34, the printer 35, the automatic change machine 36, or the cashless settlement terminal 37 as in an embodiment already explained above. That is, the settlement device may be a settlement device called two-way POS terminal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A settlement device for retail transaction settlement processing, the settlement device comprising:
a clerk display unit;
a customer display unit; and
a processor configured to:
receive a designation of whether a customer in a sales transaction is an electronic receipt service member,
cause the customer display unit to display a first display screen with selectable options for transaction receipt output when the received designation indicates the customer is not the electronic receipt service member and a second display screen with selectable options for transaction receipt output when the received designation indicates the customer is the electronic receipt service member, the selectable options of the first display screen being different from the selectable options of the second display screen,
receive a selection of a selectable option on the first or second display screen, and
perform processing for the transaction receipt output according to the received selection of the selectable option.

2. The settlement device according to claim 1, wherein the processor is further configured to:
perform settlement processing for settling the sales transaction.

3. The settlement device according to claim 1, further comprising:
an input interface, wherein
the designation of whether the customer in the sales transaction is an electronic receipt service member is received via the input interface.

4. The settlement device according to claim 3, wherein the processor is further configured to:
perform registration processing on items in the sales transaction based on commodity information received via the input interface.

5. The settlement device according to claim 1, wherein
the selectable options on the first display screen include a standard paper receipt option, a no receipt option, and a memo receipt option, and
the selectable options on the second display screen include an electronic receipt option and a memo receipt option.

6. The settlement device according to claim 5, wherein, when the memo receipt option is selected on the second display screen, the processing for the transaction receipt output includes both processing for output of an electronic receipt and a printing of a paper memo receipt.

7. The settlement device according to claim 1, wherein the processor is further configured to:
cause the customer display unit to display a payment method selection screen permitting the customer to select a payment method to be used for settlement processing for settling the sales transaction, and
perform settlement processing for settling the sales transaction according to the payment method selected by the customer on the payment method selection screen.

8. The settlement device according to claim 7, wherein the selection of the selectable option on the first or second display screen must be received before the payment method selection screen is displayed by the customer display unit.

9. The settlement device according to claim 1, further comprising:
a printer for printing paper receipts.

10. The settlement device according to claim 1, wherein the processor is further configured to:
receive a selection of a switching button via the clerk display unit while the first or second display screen is displayed by the customer display unit and then display a receipt format selection screen on the clerk display unit.

11. A point-of-sale system, comprising:
a checkout counter;
a registration input device mounted on the checkout counter and configured to permit a clerk to register items in a sales transaction for a customer; and
a customer settlement device separated from the checkout counter, the customer settlement device including:
a clerk display unit facing towards a space in which the clerk stands while operating the registration input device;
a customer display unit facing towards a space in which a customer stands while operating the customer settlement device; and
a processor configured to:
receive a designation from the registration input device indicating whether the customer is an electronic receipt service member,
cause the customer display unit to display a first display screen with selectable options for transaction receipt output when the received designation indicates the customer is not the electronic receipt service member and a second display screen with selectable options for transaction receipt output when the received designation indicates the customer is the electronic receipt service member, the selectable options of the first display screen being different from the selectable options of the second display screen,
receive a selection of a selectable option on the first or second display screen, and
perform processing for the transaction receipt output according to the received selection of the selectable option.

12. The point-of-sale system according to claim 11, wherein the processor is further configured to:
perform settlement processing for settling the sales transaction.

13. The point-of-sale system according to claim 11, wherein
the selectable options on the first display screen include a standard paper receipt option, a no receipt option, and a memo receipt option, and
the selectable options on the second display screen include an electronic receipt option and a memo receipt option.

14. The point-of-sale system according to claim 13, wherein, when the memo receipt option is selected on the second display screen, the processing for the transaction receipt output includes both processing for output of an electronic receipt and a printing of a paper memo receipt.

15. The point-of-sale system according to claim 11, wherein
the processor is further configured to:
cause the customer display unit to display a payment method selection screen permitting the customer to select a payment method to be used for settlement processing for settling the sales transaction, and
perform settlement processing for settling the sales transaction according to the payment method selected by the customer on the payment method selection screen, and
the selection of the selectable option on the first or second display screen must be received before the payment method selection screen is displayed by the customer display unit.

16. The point-of-sale system according to claim 11, wherein the processor is further configured to:
receive a selection of a switching button via the clerk display unit while the first or second display screen is displayed by the customer display unit and then display a receipt format selection screen on the clerk display unit.

17. A method for a settlement device, the method comprising:
receiving, from a registration input terminal, a designation of whether a customer in a sales transaction is an electronic receipt service member;
causing a customer display unit of a settlement device to display a first display screen with selectable options for transaction receipt output when the received designation indicates the customer is not the electronic receipt service member and a second display screen with selectable options for transaction receipt output when the received designation indicates the customer is the electronic receipt service member, the selectable options of the first display screen being different from the selectable options of the second display screen;
receiving a selection of a selectable option on the first or second display screen; and
performing processing for the transaction receipt output according to the received selection of the selectable option.

18. The method according to claim 17, further comprising:
performing settlement processing for settling the sales transaction.

19. The method according to claim 17, wherein
the selectable options on the first display screen include a standard paper receipt option, a no receipt option, and a memo receipt option, and
the selectable options on the second display screen include an electronic receipt option and a memo receipt option.

20. The method according to claim 17, further comprising:
performing registration processing on items in the sales transaction based on commodity information received via the registration input terminal.
